(19) United States
(12) Patent Application Publication
(10) Pub. No.: US 2024/0320345 A1
(43) Pub. Date: Sep. 26, 2024

(54) ELECTRONIC CONTROL APPARATUS FOR VEHICLE AND DATA TRANSMITTING AND RECEIVING METHOD THEREOF

(71) Applicant: HL MANDO CORPORATION, PYEONGTAEK-SI (KR)

(72) Inventor: Taewoong OH, Suwon-si (KR)

(21) Appl. No.: 18/371,082

(22) Filed: Sep. 21, 2023

(30) Foreign Application Priority Data
Mar. 22, 2023 (KR) 10-2023-0037070

(51) Int. Cl. G06F 21/60

(52) U.S. Cl. CPC G06F 21/602

(57) ABSTRACT

Disclosed herein are an electronic control apparatus for a vehicle and a data transmitting and receiving method thereof. The electronic control apparatus for a vehicle in accordance with the present embodiment includes an encryption module configured to encrypt data received from a control software using a master key or decrypt encrypted data received from the outside using the master key, and a failsafe module configured to detect contamination of the data by comparing the encrypted data with the decrypted data.

### CROSS-REFERENCE TO RELATED APPLICATION

This application claims the benefit of Korean Patent Application No. 10-2023-0037070, filed on Mar. 22, 2023 in the Korean Intellectual Property Office, the disclosure of which is incorporated herein by reference.

### BACKGROUND

### 1. Field

Embodiments of the present disclosure relate to an electronic control apparatus for a vehicle and a data transmitting and receiving method thereof, and more particularly, to an electronic control apparatus for a vehicle capable of preventing data of the electronic control apparatus for a vehicle from being exposed to unauthorized persons, and a data transmitting and receiving method thereof.

### 2. Description of the Related Art

In general, a vehicle is applied with various electronic control devices such as electronic stability control (hereinafter, ESC) and electronic parking brake (hereinafter, EPB) to improve driving stability and enhance a driver's comfort. These electronic control devices for a vehicle may be connected to each other through a communication line and form a communication network.

More specifically, the ESC is a device that prevents the vehicle from being driven against a driver's will, and is a system that controls the vehicle by forcibly intervening a computer program in a throttle, a brake, and the like.

In addition, the EPB is a device that automatically applies the brake when a driver pulls over or stops the vehicle and automatically releases the brake when the driver depresses an accelerator pedal upon departure, and works in conjunction with the ESC to improve a control function, such as preventing the vehicle from spinning in an emergency braking situation using a parking brake.

There is a problem that when the electronic control devices for a vehicle such as the ESC and EPB are interconnected and transmit and receive signals for each other, it often happens that unauthorized persons control the electronic control devices for a vehicle or steal data.

In particular, the EPB is being developed in a way in which an EPB software is embedded in an ESC module that includes a non-volatile memory (electrically erasable programmable read-only memory, hereinafter, EEPROM). In this process, when a developer or a development company of the EPB is different from those of the ESC, the EPB data needs to be provided to the ESC developer. Therefore, there is a problem that the EPB data is exposed to unauthorized persons or contamination of the EPB data occurs.

### SUMMARY

Therefore, it is an aspect of the present disclosure to provide an electronic control apparatus for a vehicle capable of preventing data of the electronic control apparatus for a vehicle from being exposed to unauthorized persons, and a data transmitting and receiving method thereof.

It is another aspect of the present disclosure to provide an electronic control apparatus for a vehicle capable of detecting contamination of data of the electronic control apparatus for a vehicle due to transmitting and receiving data with an external system, and a data transmitting and receiving method thereof.

In accordance with one aspect of the present disclosure, there is provided an electronic control apparatus for a vehicle including: an encryption module configured to encrypt data received from a control software using a master key or decrypt encrypted data received from the outside using the master key, and a failsafe module configured to detect contamination of the data by comparing the encrypted data with the decrypted data.

The control software may use the decrypted data for calculation.

The control software may use the decrypted data in which contamination is not detected by the failsafe module for calculation.

The control software may include a tuning parameter including the master key.

The encryption module may include a first subkey and a second subkey, each of which is generated from the master key and used for encryption and decryption of the data.

The encryption module may include a simplified data encryption standard (S-DES) algorithm for encrypting or decrypting the data.

The encrypted data and the decrypted data may include the same information in the same array.

The failsafe module may detect contamination of the data by decrypting the encrypted data, encrypting the decrypted data, and recomparing the encrypted data with the decrypted data.

The failsafe module may output a corresponding notification signal to the outside upon detecting contamination of the data.

In accordance with another aspect of the present disclosure, there is provided a data transmitting and receiving method of an electronic control apparatus for a vehicle, the method including encrypting data received from a control software using a master key and transmitting the data to the outside, decrypting the encrypted data received from the outside using the master key, and detecting contamination of the data by comparing the encrypted data with the decrypted data.

The data transmitting and receiving method may include using the decrypted data for calculation of the control software.

The data transmitting and receiving method may include using the decrypted data in which contamination of the data is not detected by comparing the encrypted data with the decrypted data, for calculation of the control software.

The control software may include a tuning parameter including the master key.

The encrypting of the data using the master key may include encrypting the data using a first subkey and a second subkey generated from the master key.

The decrypting of the encrypted data using the master key may include decrypting the encrypted data using a first subkey and a second subkey generated from the master key.

The encrypting of the data using the master key may include encrypting the data using a simplified data encryption standard (S-DES) encryption algorithm.

The decrypting of the encrypted data using the master key may include decrypting the data using a simplified data encryption standard (S-DES) decryption algorithm.

The encrypted data and the decrypted data may include the same information in the same array.

The detecting of contamination of the data may further include decrypting the encrypted data, encrypting the decrypted data, and recomparing the encrypted data with the decrypted data to detect contamination of the data.

The detecting of contamination of the data may further include outputting a corresponding notification signal to the outside upon detecting the contamination of the data.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram illustrating a main configuration of an electronic control apparatus for a vehicle in accordance with one embodiment of the present disclosure;

FIG. 2 is a block diagram for describing a process of transmitting and receiving data between the electronic control apparatus for a vehicle in accordance with one embodiment of the present disclosure and an electronic control apparatus for another vehicle;

FIG. 3 is a flowchart illustrating a sequence of a data transmitting and receiving method of the electronic control apparatus for a vehicle in accordance with one embodiment of the present disclosure; and

FIG. 4 is a flowchart illustrating a sequence of a method of detecting contamination of data in the data transmitting and receiving method of the electronic control apparatus for a vehicle in accordance with one embodiment of the present disclosure.

### DETAILED DESCRIPTION

Hereinafter, embodiments of the present disclosure will be described in detail with reference to the accompanying drawings. The embodiments below are presented to sufficiently convey the ideas of the present disclosure to those skilled in the art to which the present disclosure belongs. The present disclosure is not limited to the embodiments presented herein and may be specified as other forms. To clarify the present disclosure, the drawings may omit the illustration of parts that are not related to the description, and the size of components may be somewhat exaggerated for ease of understanding.

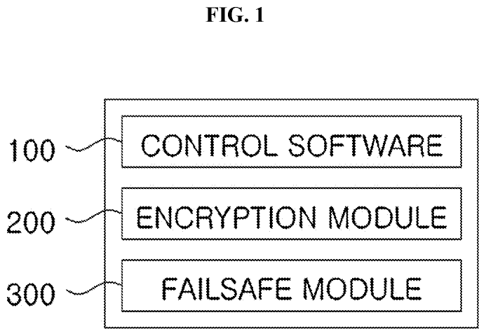

FIG. 1 is a block diagram illustrating a main configuration of an electronic control apparatus for a vehicle in accordance with one embodiment of the present disclosure.

With reference to FIG. 1, the electronic control apparatus for a vehicle in accordance with one embodiment of the present disclosure includes a control software 100, an encryption module 200, and a failsafe module 300.

The control software 100 includes data and programs for controlling various electronic control systems, including a braking system, a steering system, a drive system, a multimedia system, and the like, of a vehicle.

The encryption module 200 encrypts or decrypts the data received from the control software 100 using a master key 120.

In this case, the master key 120 may be included in a tuning parameter 110 included in the control software 100 to prevent external exposure and to be shared only between development projects.

In addition, the encryption module 200 encrypts the data received from the control software 110 using a first subkey 121 and a second subkey 122 generated by the master key 120.

The encryption module 200 may include a simplified data encryption standard (S-DES) algorithm for encrypting or decrypting the data in order to minimize performance degradation of the electronic control apparatus for a vehicle due to a load caused by encryption of the data. Accordingly, the master key 120 may be provided as a 10-bit key.

More specifically, the S-DES algorithm includes an S-DES encryption algorithm and an S-DES decryption algorithm.

The S-DES encryption algorithm outputs an 8-bit ciphertext block with an 8-bit plaintext block and the 10-bit key as input. In addition, the S-DES decryption algorithm outputs an original 8-bit plaintext block with the 8-bit ciphertext block and the 10-bit key used to generate the ciphertext as input.

The encryption module 200 transmits the encrypted data to the outside. As used herein, the outside may refer to an electronic control apparatus for another vehicle in conjunction with the electronic control apparatus for a vehicle of one embodiment of the present disclosure.

The encryption module 200 decrypts the encrypted data received from the outside. In this case, the encryption module 200 may decrypt the encrypted data using the first subkey 121 and the second subkey 122 generated by the master key 120.

Accordingly, the electronic control apparatus for a vehicle in accordance with one embodiment of the present disclosure can improve security of the electronic control apparatus for a vehicle by preventing data of the electronic control apparatus for a vehicle from being exposed to unauthorized persons.

Meanwhile, the failsafe module 300 detects whether the data is contaminated by comparing the encrypted data with the decrypted data, on the premise that the encrypted data and the decrypted data include the same information in the same array, as described above.

The failsafe module 300 may be provided to detect contamination of the data by decrypting the encrypted data, encrypting the decrypted data, and recomparing the encrypted data with the decrypted data to further improve reliability of the data contamination detection.

When detecting data contamination, the failsafe module 300 may also be provided to output a corresponding notification signal to the outside.

Accordingly, the electronic control apparatus for a vehicle in accordance with one embodiment of the present disclosure can improve reliability of the electronic control apparatus for a vehicle by detecting contamination of data of the electronic control apparatus for a vehicle due to transmission or reception of data with an external system.

In addition, the electronic control apparatus for a vehicle in accordance with one embodiment of the present disclosure may be included in an electronic control device for a vehicle for controlling various electronic control systems including a braking system, a steering system, a drive system, a multimedia system, and the like that are provided in the vehicle, as well as in a smart key or a portable terminal of a driver or developer that is provided outside the vehicle.

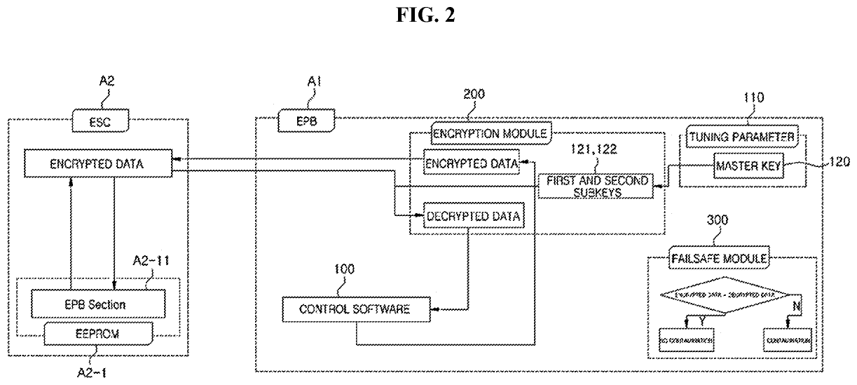

FIG. 2 is a block diagram for describing a process of transmitting and receiving data between the electronic control apparatus for a vehicle in accordance with one embodiment of the present disclosure and the electronic control apparatus for another vehicle.

With reference to FIG. 2, an electronic control apparatus for a vehicle A1 in accordance with one embodiment of the present disclosure may be an electronic parking brake (EPB) device, and an electronic control apparatus for another vehicle A2 may be an electronic stability control (ESC) device.

The EPB A1 and the ESC A2 may be connected to each other through a communication line and form a communication network.

The ESC A2 may include a non-volatile memory (electrically erasable programmable read-only memory, hereinafter referred to as EEPROM A2-1) in which data received from the EPB A1 is stored.

In addition, the EEPROM A2-1 may include an EPB section A2-11 in which the data received from the EPB A1 is stored.

First, when the EPB A1 receives a request for writing EEPROM data from the ESC A2, the EPB A1 outputs data corresponding to the data requested from the control software 100 to the encryption module 200.

Thereafter, the encryption module 200 encrypts the data received from the control software 100 using the first subkey 121 and the second subkey 122 that are generated from the master key 120 and the simplified data encryption standard (S-DES) algorithm, and transmits the data to the ESC A2.

Accordingly, the electronic control apparatus for a vehicle in accordance with one embodiment of the present disclosure can improve security of the electronic control apparatus for a vehicle by preventing data of the electronic control apparatus for a vehicle from being exposed to unauthorized persons.

Subsequently, the ESC A2 stores the encrypted data received from the encryption module 200 in the EEPROM A2-1.

Meanwhile, when the EPB A1 receives a request for reading EEPROM data from the ESC A2, the encryption module 200 receives and decrypts the encrypted data as described above using the first subkey 121 and the second subkey 122 that are generated from the master key 120 and the simplified data encryption standard (S-DES) algorithm.

In this case, the first subkey 121 and the second subkey 122 are used for both encryption and decryption of the data as described above, and there is a difference only in the order of use.

That is, if the first subkey 121 and the second subkey 122 are sequentially used to encrypt the data, the second subkey 122 and the first subkey 121 are sequentially used to decrypt the data.

Thereafter, the failsafe module 300 compares the encrypted data with the decrypted data to detect contamination of the data.

In this case, when detecting the contamination of the data, the failsafe module 300 outputs a corresponding signal to the outside.

As used herein, the outside may include a display provided in the vehicle, a driver's or developer's terminal, or the like.

Meanwhile, when the data is detected to be free of contamination by the failsafe module 300, the control software 100 performs a calculation using the decrypted data.

Accordingly, the electronic control apparatus for a vehicle in accordance with one embodiment of the present disclosure can improve reliability of the electronic control apparatus for a vehicle by detecting contamination of data of the electronic control apparatus for a vehicle due to transmission or reception of data with an external system.

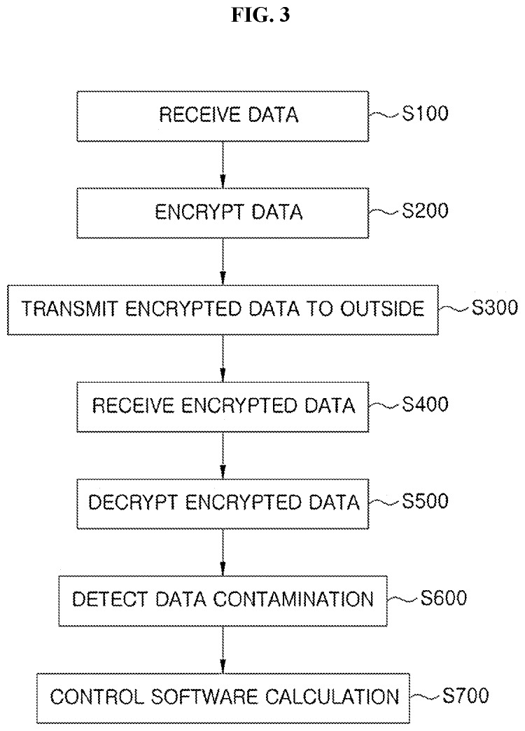

FIG. 3 is a flowchart illustrating a sequence of a data transmitting and receiving method of the electronic control apparatus for a vehicle in accordance with one embodiment of the present disclosure.

With reference to FIG. 3, the data transmitting and receiving method of the electronic control apparatus for a vehicle in accordance with one embodiment of the present disclosure includes encrypting (200) data received (100) from a control software 100 using a master key 120 and transmitting (300) the encrypted data to the outside, decrypting (500) the encrypted data received (400) from the outside using the master key 120, and detecting (600) contamination of the data by comparing the encrypted data with the decrypted data.

As used herein, the outside may refer to an electronic control apparatus for another vehicle in conjunction with the electronic control apparatus for a vehicle of one embodiment of the present disclosure.

In addition, the data transmitting and receiving method of the electronic control apparatus for a vehicle includes using the decrypted data for calculation (700) of the control software 100.

Furthermore, the data transmitting and receiving method of the electronic control apparatus for a vehicle may include using the decrypted data in which no contamination of the data is detected for calculation (700) of the control software 100 by comparing the encrypted data with the decrypted data.

The control software 100 may include a tuning parameter 110 that includes the master key 120. Here, the tuning parameter 110 is a developer area for fine-tuning the control software 100 and may be provided to block any access by unauthorized persons.

Accordingly, the data transmitting and receiving method of the electronic control apparatus for a vehicle in accordance with one embodiment of the present disclosure can improve security of the electronic control apparatus for a vehicle by preventing data of the electronic control apparatus for a vehicle from being exposed to unauthorized persons.

Meanwhile, the encrypting of the data (200) using the master key 120 includes encrypting the data using a first subkey 121 and a second subkey 122 generated from the master key 120.

In addition, the decrypting of the encrypted data using the master key 120 (500) includes decrypting the encrypted data using the first subkey 121 and the second subkey 122 generated from the master key 120.

In this case, if the subkeys are used in the order of the first subkey 121 and the second subkey 122 when the data is encrypted (200), the subkeys are used in the order of the second subkey 122 and the first subkey 121 when the data is decrypted (300).

More specifically, the encrypting of the data (200) using the master key 120 includes encrypting the data using a simplified data encryption standard (S-DES) encryption algorithm to minimize performance degradation of the electronic control apparatus for a vehicle due to the load caused by encrypting the data.

In addition, the decrypting of the encrypted data using the master key (300) includes decrypting the data using the simplified data encryption standard (S-DES) decryption algorithm in order to minimize performance degradation of the electronic control apparatus for a vehicle due to the load caused by the decryption of the data. Accordingly, the master key 120 may be provided as a 10-bit key.

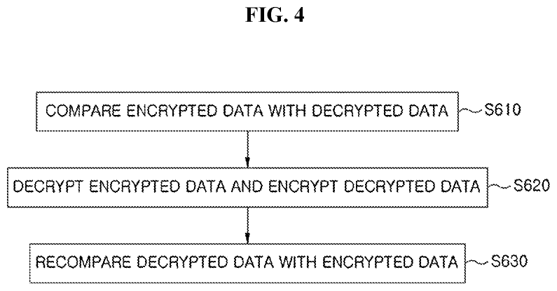

FIG. 4 is a flowchart illustrating a sequence of a method of detecting contamination of data in the data transmitting and receiving method of the electronic control apparatus for a vehicle in accordance with one embodiment of the present disclosure.

With reference to FIG. 4, the detecting of the contamination of the data (600) may further include, on the premise that the encrypted data and the decrypted data include the same information in the same array, comparing the encrypted data with the decrypted data (610), decrypting the encrypted data, encrypting the decrypted data (620), and recomparing the encrypted data with the decrypted data (630) to detect the contamination of the data.

In addition, the detecting of the contamination of the data (600) may further include outputting a corresponding notification signal to the outside upon detecting the contamination of the data.

As used herein, the outside may include a display provided in the vehicle, a driver's or developer's terminal, or the like.

Accordingly, the data transmitting and receiving method of the electronic control apparatus for a vehicle in accordance with the present embodiment can improve reliability of the electronic control apparatus for a vehicle by detecting contamination of data of the electronic control apparatus for a vehicle due to transmission or reception of data with an external system.

In accordance with an electronic control apparatus for a vehicle and a data transmitting and receiving method thereof of the present embodiment, it is possible to improve security of the electronic control apparatus for a vehicle by preventing data of the electronic control apparatus for a vehicle from being exposed to unauthorized persons.

In accordance with an electronic control apparatus for a vehicle and a data transmitting and receiving method thereof of the present embodiment, it is possible to improve reliability of the electronic control apparatus for a vehicle by detecting contamination of data of the electronic control apparatus for a vehicle due to transmission or reception of data with an external system.

As described above, the disclosed embodiments have been described with reference to the accompanying drawings. A person skilled in the art to which the present disclosure belongs will understand that the present disclosure may be carried out in different forms from the disclosed embodiments without changing the technical spirit or the essential characteristics of the present disclosure. The disclosed embodiments are exemplary and should not be interpreted as being restrictive.

What is claimed is:

1. An electronic control apparatus for a vehicle comprising:
an encryption module configured to encrypt data received from a control software using a master key or decrypt encrypted data received from the outside using the master key; and
a failsafe module configured to detect contamination of the data by comparing the encrypted data with the decrypted data.

2. The electronic control apparatus of claim 1, wherein the control software uses the decrypted data for calculation.

3. The electronic control apparatus of claim 1, wherein the control software uses the decrypted data in which contamination is not detected by the failsafe module for calculation.

4. The electronic control apparatus of claim 1, wherein the control software includes a tuning parameter including the master key.

5. The electronic control apparatus of claim 1, wherein the encryption module includes a first subkey and a second subkey, each of which is generated from the master key and used for encryption and decryption of the data.

6. The electronic control apparatus of claim 1, wherein the encryption module includes a simplified data encryption standard (S-DES) algorithm for encrypting or decrypting the data.

7. The electronic control apparatus of claim 1, wherein the encrypted data and the decrypted data include the same information in the same array.

8. The electronic control apparatus of claim 1, wherein the failsafe module detects contamination of the data by decrypting the encrypted data, encrypting the decrypted data, and recomparing the encrypted data with the decrypted data.

9. The electronic control apparatus of claim 1, wherein the failsafe module outputs a corresponding notification signal to the outside upon detecting contamination of the data.

10. A data transmitting and receiving method of an electronic control apparatus for a vehicle, the method comprising:
encrypting data received from a control software using a master key and transmitting the data to the outside;
decrypting the encrypted data received from the outside using the master key; and
detecting contamination of the data by comparing the encrypted data with the decrypted data.

11. The data transmitting and receiving method of claim 10, comprising using the decrypted data for calculation of the control software.

12. The data transmitting and receiving method of claim 10, comprising using the decrypted data in which contamination of the data is not detected by comparing the encrypted data with the decrypted data for calculation of the control software.

13. The data transmitting and receiving method of claim 10, wherein the control software includes a tuning parameter including the master key.

14. The data transmitting and receiving method of claim 10, wherein the encrypting of the data using the master key includes encrypting the data using a first subkey and a second subkey generated from the master key.

15. The data transmitting and receiving method of claim 10, wherein the decrypting of the encrypted data using the master key includes decrypting the encrypted data using a first subkey and a second subkey generated from the master key.

16. The data transmitting and receiving method of claim 10, wherein the encrypting of the data using the master key includes encrypting the data using a simplified data encryption standard (S-DES) encryption algorithm.

17. The data transmitting and receiving method of claim 10, wherein the decrypting of the encrypted data using the master key includes decrypting the data using a simplified data encryption standard (S-DES) decryption algorithm.

18. The data transmitting and receiving method of claim 10, wherein the encrypted data and the decrypted data include the same information in the same array.

19. The data transmitting and receiving method of claim 10, wherein the detecting of contamination of the data further includes decrypting the encrypted data, encrypting the decrypted data, and recomparing the encrypted data with the decrypted data to detect contamination of the data.

20. The data transmitting and receiving method of claim 10, wherein the detecting of contamination of the data further includes outputting a corresponding notification signal to the outside upon detecting contamination of the data.
